(19) United States
(12) Patent Application Publication
(10) Pub. No.: US 2007/0258752 A1
(43) Pub. Date: Nov. 8, 2007

(54) Writing instrument fitted with a filing sleeve having an abrasive surface

(76) Inventor: John O'Hern, Hoboken, NJ (US)

Correspondence Address: FROMMER LAWRENCE & HAUG, 745 FIFTH AVENUE- 10TH FL., NEW YORK, NY, 10151, US

(21) Appl. No.: 11/416,752

(22) Filed: May 3, 2006

(51) Int. Cl. B43K 29/00; B43K 25/00

(52) U.S. Cl. 401/195; 401/52

(57) ABSTRACT

A combination filing sleeve and writing instrument is provided in which the filing sleeve has an abrasive surface. The filing sleeve, when installed, provides the writing instrument with a nail shaping surface along the length of the filing sleeve. The external surface of the filing sleeve has one or more grades of abrasiveness and may be a variety of configurations, including circular or three, four, or five sided.

### FIELD OF THE INVENTION

The present invention relates to a filing sleeve, and more particularly, to a filing sleeve installed on a writing instrument that has associated therewith, one or more abrasive surfaces that are adapted to shape fingernails.

### BACKGROUND DISCUSSION

There are various implements that are used for shaping finger nails, many of which are simply nail files and have no other useful purpose. As such, those devices are simply carried and used by themselves. On the other hand, there are other devices that have been disclosed and which are combination devices such that the device not only comprises a nail file but may also have an additional purpose. Such combination devices are of an added convenience to the user, particularly if the other use of the device is also a use that would normally entail a device that is carried on one's person such as, for example, in a woman's purse.

Accordingly such combination devices can be employed to combine two or more functions in a single device. One of such combination device combines the functions of a writing instrument while also providing the convenience and utility of being usable for shaping nails, that is, of being used as a nail file.

One such device that is a combination of a writing instrument and a nail shaping device is U.S. Pat. No. 6,572,299 to Brennan (hereinafter, merely “Brennan”). Brennan discloses a writing instrument in which an abrasive strip or strips is formed substantially along the length of the main body of the writing instrument. Brennan also discloses that abrasive strips can be located in slots that are formed along the main body of the writing instrument. There are two drawbacks to the slotted design of Brennan. First, in terms of production, the slotting process is complicated and costly. Second, the slotted files are not user-friendly, because they are of limited surface area.

Another example of a device that combines the functions of a writing instrument and a nail shaping device is shown and described in U.S. Pat. No. 5,090,427 of Sherts (hereinafter, merely “Sherts”). The Sherts patent discloses a writing instrument that includes a means for pushing back the cuticle of the finger as well as having an abrasive strip that can be used for shaping of fingernails. One disadvantage of the Sherts device, however, lies in the location of the cuticle pusher and the abrasive strip. Both functions are located on the cap of the writing instrument and, as such, the cap may become disengaged from the main body of the instrument during use or, alternatively, can be disengaged to carry out its fingernail shaping function and inadvertently misplaced so that the cap is not replaced on the body of the writing instrument. Furthermore, the overall length of the strip of abrasive material, being confined to the cap of the writing instrument, is limited and, as such, the user cannot get a full stroke or full effective use of the nail shaping function.

In additional combination devices of the type discussed, there has also been disclosed, a clip attachment for a pocket carried device, such as a pen in U.S. Pat. No. 1,478,049. However, again, the length of the abrasive surface usable to carry out the shaping of a fingernail is limited due to the physical dimensions of a clip employed with a pen and its alternate function of clipping the pen to the pocket of a user.

Other examples of such combination devices that have also been disclosed include Design Pat. No. 257,181 to Brown and U.S. Pat. No. 2,841,156 of Herald, both of which devices are also limited in overall length since they also rely on the clip of a pen for the location of the abrasive strip and thus suffer from the same drawbacks as the previously discussed combination devices. In addition, of course, such constructions severely limit the width of the strip of abrasive material that can be associated with the clips used with pens.

In addition to the problem or deficiency of the aforedescribed prior art devices, relative to the limited length of the abrasive strip, by utilizing the clip, cap, slot, or other relatively small component of the writing instrument, the device is limited in the width of the abrasive material and cannot physically provide more than one relatively narrow strip of such material. Thus, with any of these combination devices, it would not be practical to include more than one strip of the abrasive material, such as would be advantageous of a user desiring more the one abrasive strip so as to have differing grades of abrasiveness, that is, if a user were to desire a device having one strip of a material that is a coarse abrasive and a second strip of a material with a finer abrasiveness on the same writing instrument.

It would therefore be advantageous to have a writing instrument that can be used with a longer and wider surface or strip of abrasive material, but in addition, can have the capability, dimensionally, to provide more than one abrasive surface with differing grades of abrasive materials so that the user can have additional flexibility and functionality in utilizing the nail shaping function while not detracting from the writing capability of the writing instrument.

### SUMMARY OF THE INVENTION

The present invention provides a filing sleeve with a nail shaping function that overcomes the problems and deficiencies of the aforedescribed prior art combination devices. Thus, in accordance with the present invention, a combination filing sleeve and writing instrument is provided in which the filing sleeve has an abrasive surface and the writing instrument comprises a main body on to which the filing sleeve is installed. The filing sleeve, when installed, provides the writing instrument with a nail shaping function along the length of the tubular body. Therefore, the abrasive surface can be extended in length over those uses where the abrasive strip is oriented on the clip or cap of the writing instrument.

The particular writing instrument may be, for example, a pencil, ink pen, ball point pen, or a fountain pen, or the like and preferably a ball point. As is normal with such instruments, the writing substance is located within the main body of the instrument and, as stated, can be either pencil lead, a normal liquid ink or an ink cartridge for a ball point pen. The exterior surface of the body of the writing instrument can also be of a variety of configurations or shapes, including square, rectangular, oval, round or other geometrical or non-geometrical shapes.

In one embodiment of the present invention, the exterior surface of the filing sleeve is four sided and the entire surface is abrasive. However, the exterior surface of the filing sleeve may be any shape, including circular, three sided, and five sided, and may have an abrasive surface located on any, some, or all of the surfaces. The exterior surface of the main body and the exterior surface of the filing sleeve may be of the same shape or dissimilar shapes.

Preferably, in the case of a square external configuration for the filing sleeve, two abrasive surfaces are located on the sleeve. Two contiguous sides will have one grade of abrasive surface and the remaining sides will have another grade of abrasive material. With other external surface configurations of the filing sleeve, the multiple or plurality of such abrasive surfaces may be contiguous to each other or may be separated by some non-abrasive surface. Also, in some instances all sides of the filing sleeve will be covered with a single grade of abrasive surface.

Preferably, the interior surface of the filing sleeve and the exterior surface of the writing instrument may be threaded. The covering can therefore, be twisted onto the writing instrument. Therefore, a filing sleeve is easily installed or removed, and can be replaced quickly. For example, the writing instrument and the filing sleeve can be separated if an abrasive surface is worn or the writing instrument runs out of ink or other replacement of a component is desired or required.

However, the exterior surface of the writing instrument and the interior surface of the covering may be smooth. Installation of the covering may be done by sliding the covering on the writing instrument. For permanent installation, the filing sleeve may be adhered to the writing instrument.

As is also preferred in the present invention, where two or more abrasive surface are located on the external surface of the filing sleeve, the individual surfaces may have differing grades of abrasiveness, that is, one of the surfaces may have a coarse abrasive material while the other surface may be comprised of a finer abrasive material so that the user can initially shape the fingernail with the coarser material and finish the shaping of the fingernail with the finer abrasive material.

The abrasive surface of the filing sleeve itself, can be provided in the form of a strip that is affixed to the exterior surface of the exterior surface of the filing sleeve by means of an adhesive or can be actually molded into or pressed into the external plastic material of the filing sleeve and thus embedded into that external surface. As a further embodiment, the strip of abrasive material may be separately provided and slipped into a special formed external slotted surface on the external surface thereof, and then further affixed thereto by an adhesive.

Thus, as explained, with the present invention, there is provided a filing sleeve for a writing instrument having an abrasive material located on the exterior surface and therefore can be considerably wider and longer in overall length of the abrasive surface as compared to device in which the abrasive material is applied to a limited area on the instrument such as the cap of a pen, a slot on the pen, or a clip. In addition, with the additional external surface area that is therefore available on the present writing instrument, there can be provided a plurality of surfaces of the abrasive material and thereby give the user additional flexibility in being able to have a plurality of surfaces of abrasive material having differing grades of abrasiveness. The increased surface area and additional flexibility in grades of abrasiveness gives the user an improved nail filing and nail care experience.

Furthermore, the threaded design of the filing sleeve improves the speed and ease in which the filing sleeve can be installed, removed, or replaced, by the manufacturer and the user. The process is simple and inexpensive.

Other features of the filing sleeve and writing instrument will become apparent in light of the following detailed description of a preferred embodiment thereof and as illustrated in the accompanying drawings.

### BRIEF DESCRIPTION OF THE DRAWINGS

FIG. 1 shows a perspective view of a writing instrument fitted with the filing sleeve in accordance with the present invention;

FIG. 2 shows a perspective view of a second embodiment of the writing instrument fitted with the filing sleeve;

FIG. 3 shows a perspective view an another embodiment of the writing instrument where the writing instrument has a recessed portion that can accommodate the filing sleeve; and

FIG. 4 shows a perspective view of a further embodiment of the present invention.

### DETAILED DESCRIPTION OF THE INVENTION

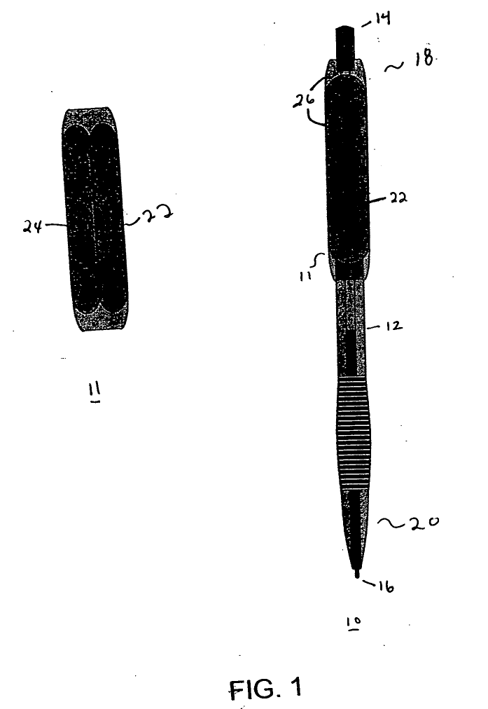

FIG. 1 shows a perspective view of a writing instrument 10 fitted with a filing sleeve 11 in accordance with the present invention. In the embodiment of FIG. 1, the writing instrument 10 comprises a main body 12 having a predetermined external surface having a circular configuration. As is normal for certain of such writing instruments 10, this embodiment is typical of a ball point pen and therefore includes a button 14 located on the writing instrument 10 in order to operate the device and to move the point 16 of the ball point cartridge contained within the main body 12 from an exposed position as shown in FIG. 1 to a retracted position as is conventional with such writing instruments 10. Accordingly, although a ball point pen embodiment is shown and described hereinafter with respect to FIG. 1, it will be seen that the writing instrument 10 may be any other type of similar writing instrument 10, including, but not limited to, fountain pen, a pencil, or other device.

As will also be referenced, the top end of the writing instrument 10 will be referred to as the proximal end 18 where the end of the writing instrument 10 that contacts the material for writing thereon, and where the point 16 is located will be referred to as the distal end 20. The distal end 20 narrows down in the direction of the point 16 and may become generally circular in cross section in order to be more convenient and comfortable for the user to properly grip the writing instrument 10.

The main body 12 of the writing instrument 10 has an exterior surface that can also be of a variety of configurations, including square, rectangular, oval, round or other geometrical or non-geometrical shapes.

As shown in FIG. 1, the filing sleeve 11 is typically installed covering a portion of the main body 12 of the writing instrument 10. In one embodiment, the exterior surface of the filing sleeve 11 is square and the entire surface is abrasive. As shown in FIG. 1, the filing sleeve 11 is four sided and tapers to round at the two ends. However, the exterior surface of the filing sleeve 11 may be any shape, including circular, three sided, and five sided, and may have an abrasive surface located on any or all of the surfaces.

In another embodiment of the present invention, the exterior surface of the main body 12 and the exterior surface of the filing sleeve 11 may be of the same shape or dissimilar shapes.

In one embodiment, each of the exterior sides of the filing sleeve 11 is abrasive. However, in the case of a square external configuration of the filing sleeve 11, two abrasive surfaces may be located on the sleeve 11. Two contiguous sides will have one grade of abrasive surface and the remaining two sides will have a different grade of abrasive material. In one embodiment there at least two abrasive surfaces 22, 24 formed on that exterior surface of the filing sleeve 11, and there may be a non-abrasive surface 26 located intermediate each of the abrasive strips 22, 24 to separate those strips for the convenience in using the writing instrument 10 for the shaping of the fingernails. Also, in some instances all if the filing sleeve 1I will be covered with a single grade of abrasive surface.

The actual material used for the abrasive surface of the filing sleeve 11 may be emery as is currently used in nail files and the like.

Where two or more abrasive surface are located on the external surface of the filing sleeve 11, the individual surfaces may have differing grades of abrasiveness. For example, one of the surfaces may have a coarse abrasive material while the other surface may be comprised of a finer abrasive material so that the user can initially shape the fingernail with the coarser material and finish the shaping of the fingernail with the finer abrasive material.

The abrasive surface of the filing sleeve 11 itself, can be provided in the form of a strip that is affixed to the exterior surface of the filing sleeve 11 by means of an adhesive or can be molded or pressed into the external plastic or other material of the filing sleeve 11 and thus embedded into that external surface. As a further embodiment, the strip of abrasive material may be separately provided and slipped into a special formed external slotted surface on the external surface thereof, and then further affixed thereto by an adhesive.

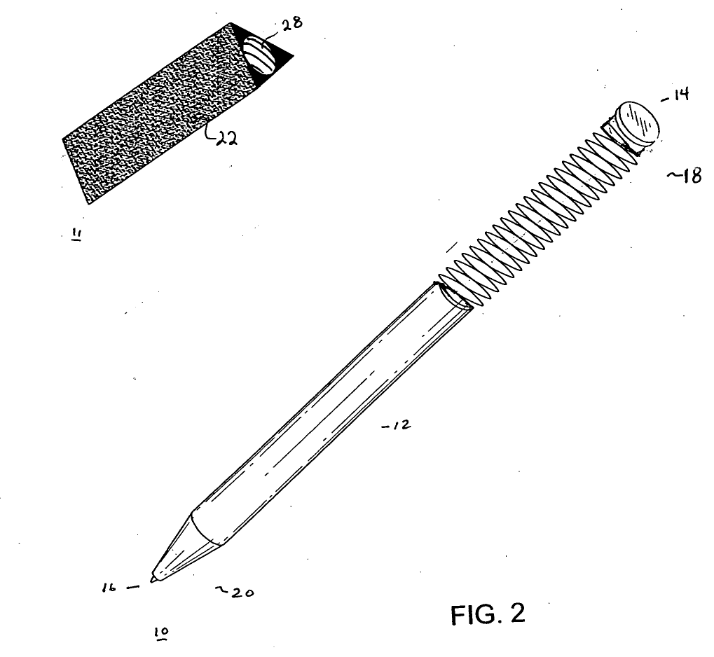

As can be seen in FIG. 2, the interior surface 28 of the filing sleeve 11 and the exterior surface of the writing instrument 10 may be threaded. The covering can therefore, be twisted or threaded onto the writing instrument 10. Therefore, a filing sleeve 11 is easily installed or removed, and can be replaced quickly. For example, the writing instrument 10 and the filing sleeve 11 can be separated if an abrasive surface is worn or the writing instrument 10 runs out of ink.

However, the exterior surface of the writing instrument 10 and the interior surface 28 of the filing sleeve 11 may be smooth. Installation of the covering may be achieved by sliding the covering on the writing instrument 10.

For permanent installation, the filing sleeve 11 may be adhered, by gluing the sleeve 11, in place. Thus, the filing sleeve 11 and main body 12 can be a writing instrument kit.

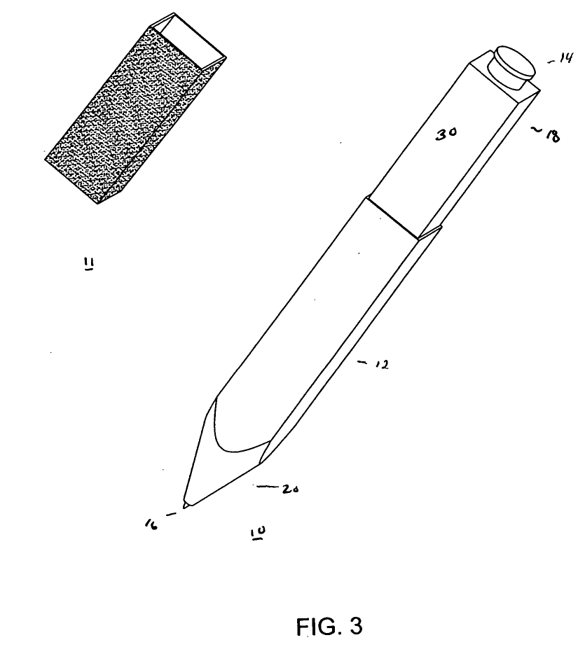

FIG. 3 shows an embodiment of the present invention where the writing instrument 10 may have a portion that is recessed 30 to accommodate the filing sleeve 11. When the filing sleeve 11 is installed, the abrasive surface of the filing sleeve and the surface of the writing instrument 10 are flush. The interior surface 28 of the filing sleeve 11 and the exterior surface of the writing instrument 10 may both be threaded or smooth.

As can be seen, by installing the filing sleeve 11 with its abrasive surfaces 22, 24 on or along substantially the entire length of the main body 12 of the writing instrument 10 by twisting or sliding it on, the user has a better grip on the writing instrument 10 to properly shape the fingernails without of the abrasive surface 22 coming loose, being misplaced and the like and also has the further advantage, as shown, that the use of the full, main body 12 also comprises the additional surface area of the external surface of the writing instrument 10 so as to enable the user the potential of a plurality of strips of abrasive material.

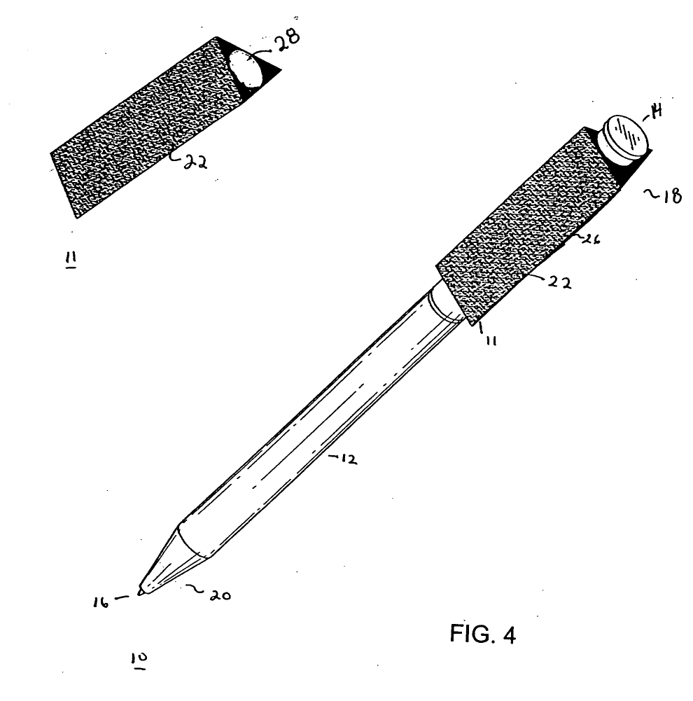

FIG. 4 shows a perspective view of a further embodiment of the present invention and where the filing sleeve 11, using the same reference numbers as FIG. 1 for similar components, has a three-sided external surface or configuration with a threaded interior surface 28. However, again, the abrasive surface 22 is formed or located substantially along the length of the main body 12 of that writing instrument 10.

Again, although the embodiment of FIG. 4 may comprise three abrasive surfaces on the exterior surface thereof, there may be a non-abrasive surface 26 located intermediate each of the abrasive surfaces 22, 24 to separate those strips for the convenience in using the writing instrument 10 for the shaping of the fingernails.

While illustrative embodiments of the invention have been described above, it is, of course, understood that various modifications will be apparent to those of ordinary skill in the art. Such modifications are within the spirit and scope of the invention, which is limited and defined only by the appended claims.

What is claimed is:

1. A writing instrument comprising:
a main body having an external surface,
wherein said main body has a proximal end and a distal end having a writing point, and a portion towards the distal end that a user grips when using the writing instrument for writing; and
a filing sleeve having an interior surface attached to the external surface of the main body,
wherein the filing sleeve has an abrasive surface.

2. The writing instrument of claim 1 wherein the exterior surface of the main body and the interior surface of the filing sleeve are threaded.

3. The writing instrument of claim 1 wherein the abrasive surface of the filing sleeve comprises one or more grades of abrasiveness.

4. A method of making a writing instrument comprising the steps of:
providing a writing instrument having a main body having an external surface,
wherein said main body has a proximal end and a distal end having a writing point, and a portion towards the distal end that a user grips when using the writing instrument for writing;
providing a filing sleeve having a interior surface that fits over the exterior surface of the main body,
wherein the filing sleeve has an abrasive surface; and
inserting the main body into the filing sleeve.

5. The method of making a writing instrument as defined in claim 4 further comprising:
securing the filing sleeve to the main body with adhesive.

6. The method of making a writing instrument as defined in claim 4 wherein the abrasive surface of the provided filing sleeve comprises one or more grades of abrasiveness.

7. A method of making a writing instrument comprising the steps of:
providing a writing instrument having a main body,
wherein an exterior surface of the main body comprises a threaded portion, and
wherein said main body has a proximal end and a distal end having a writing point, and a portion towards the distal end that a user grips when using the writing instrument for writing;
providing a filing sleeve having a threaded interior surface complementing the threaded portion of the external surface of the main body,
wherein the filing sleeve has an abrasive surface; and
twisting the filing sleeve onto the main body.

8. The method of making a writing instrument as defined in claim 7 further comprising:
securing the filing sleeve to the main body with adhesive.

9. The method of making a writing instrument as defined in claim 7 wherein the abrasive surface of the provided filing sleeve comprises one or more grades of abrasiveness.

10. A writing instrument kit comprising:
as a first component, a main body having a external surface,
wherein an exterior surface of the main body comprises a threaded portion, and
wherein said main body has a proximal end and a distal end having a writing point, and a portion towards the distal end that a user grips when using the writing instrument for writing;
as a second component, a filing sleeve having a threaded interior surface complementing the threaded portion of the external surface of the main body,
wherein the filing sleeve has an abrasive exterior surface.
